(19) United States
(12) Patent Application Publication
(10) Pub. No.: US 2014/0241486 A1
(43) Pub. Date: Aug. 28, 2014

(54) FUEL ASSEMBLY

(71) Applicant: BABCOCK & WILCOX MPOWER, INC., Charlotte, NC (US)

(72) Inventor: Miroslav Dujin, Lynchburg, VA (US)

(73) Assignee: BABCOCK & WILCOX MPOWER, INC., Charlotte, NC (US)

(21) Appl. No.: 13/777,213

(22) Filed: Feb. 26, 2013

(51) Int. Cl. G21C 3/33

(52) U.S. Cl. CPC G21C 3/3305
USPC 376/441

(57) ABSTRACT

A fuel assembly includes a plurality of fuel rods arranged in parallel and including fissile material, a plurality of guide tubes arranged in parallel with and interspersed amongst the fuel rods, an upper end fitting connected with upper ends of the guide tubes, and a lower end fitting connected with lower ends of the guide tubes. Each fuel rod includes a top end and a bottom end wherein the top end extends into the upper end fitting and/or the bottom end extends into the lower end fitting.

### BACKGROUND

The following relates to the nuclear reactor arts, nuclear power generation arts, nuclear reactor fuel arts, and related arts.

In nuclear reactor designs of the integral pressurized water (integral PWR) type, a nuclear reactor core is immersed in primary coolant water at or near the bottom of a pressure vessel. In a typical design, the primary coolant is maintained in a subcooled liquid phase in a cylindrical pressure vessel that is mounted generally upright (that is, with its cylinder axis oriented vertically). A hollow cylindrical central riser is disposed concentrically inside the pressure vessel. Primary coolant flows upward through the reactor core where it is heated and rises through the central riser, discharges from the top of the central riser, and reverses direction to flow downward back toward the reactor core through a downcomer annulus defined between the pressure vessel and the central riser. In the integral PWR design, at least one steam generator is located inside the pressure vessel, typically in the downcomer annulus. Some illustrative integral PWR designs are described in Thome et al., “Integral Helical-Coil Pressurized Water Nuclear Reactor”, U.S. Pub. No. 2010/0316181 A1 published Dec. 16, 2010 which is incorporated by reference in its entirety and in Malloy et al., “Compact Nuclear Reactor”, U.S. Pub. No. 2012/0076254 A1 published Mar. 29, 2012 which is incorporated by reference in its entirety. Other light water nuclear reactor designs such as PWR designs with external steam generators, boiling water reactors (BWRs) or so forth, vary the arrangement of the steam generator and other components, but usually locate the radioactive core at or near the bottom of a cylindrical pressure vessel in order to reduce the likelihood of air exposure of the reactor core in a loss of coolant accident (LOCA).

The nuclear reactor core is typically constructed as an array of fuel assemblies in which each fuel assembly is vertically coextensive with the height of the reactor core and the array of fuel assemblies spans the lateral dimensions of the reactor core. Each fuel assembly comprises a bundle of vertically oriented fuel rods held together by a structural skeleton comprising a set of horizontal spacer grids that are spaced apart along the vertical direction and attached to guide tubes that are interspersed amongst the fuel rods. The guide tubes serve as conduits for control rods and/or in-core instrumentation. Typically, the guide tubes are welded to the grid assemblies. Upper and lower end fittings are installed at the top and bottom of the fuel assembly, and connected to the respective upper and lower ends of the guide tubes, typically by threaded fasteners or the like. The lower end fitting serves as the fluid inlet for flow of primary coolant into the fuel assembly, and the upper end fitting serves as the fluid outlet. The end fittings include flow passages which facilitate primary coolant flow. The end fittings are sometimes referred to as nozzles.

### BRIEF SUMMARY

In accordance with one aspect, a fuel assembly includes: a plurality of fuel rods comprising fissile material and arranged mutually in parallel; a plurality of guide tubes arranged in parallel with and interspersed amongst the fuel rods; an upper end fitting connected with upper ends of the guide tubes; and a lower end fitting connected with lower ends of the guide tubes. The top ends of the fuel rods extend into the upper end fitting and/or the bottom ends of the fuel rods extend into the lower end fitting.

In accordance with another aspect, a pressurized water reactor (PWR) is disclosed, including a plurality of fuel assemblies as set forth in the immediately preceding paragraph assembled as a nuclear reactor core of the PWR.

In accordance with another aspect, a fuel assembly includes: a bundle of fuel rods comprising fissile material; a plurality of guide tubes interspersed amongst the fuel rods; a set of spacer grids connected with the guide tubes and holding the fuel rods of the bundle of fuel rods in a spaced-apart arrangement; an upper end fitting connected with upper ends of the guide tubes; and a lower end fitting connected with lower ends of the guide tubes. The fuel rods are longer than the distance between the lower surface of the upper end fitting and the upper surface of the lower end fitting. To accommodate the length of the fuel rods, the fuel rods extend into openings or through-holes of the upper end fitting, and/or the fuel rods extend into openings or through-holes of the lower end fitting.

### BRIEF DESCRIPTION OF THE DRAWINGS

FIG. 1 diagrammatically shows a side view of a fuel assembly having unrealized thermal power generation potential as recognized herein. In FIG. 1, a central portion of the fuel assembly is cut away for viewing convenience.

FIG. 2 diagrammatically shows a side view of a fuel assembly in which the bottom ends of the fuel rods extend into the lower end fitting or nozzle. In FIG. 2, a central portion of the fuel assembly is cut away for viewing convenience.

FIG. 3 diagrammatically shows a partial side view of a fuel assembly including fuel rods extending into an upper end fitting in accordance with the present disclosure.

FIG. 4 diagrammatically shows a partial side view of a fuel assembly including fuel rods extending into a lower end fitting in accordance with the present disclosure.

### DETAILED DESCRIPTION OF THE PREFERRED EMBODIMENTS

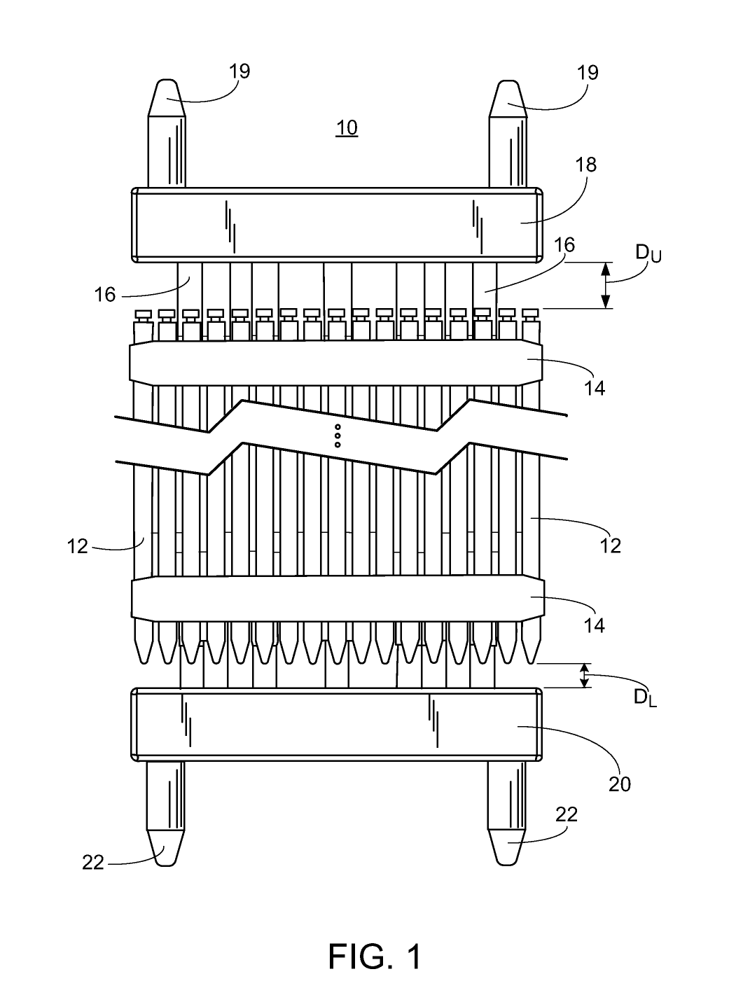

FIG. 1 illustrates a typical nuclear fuel assembly generally designated by the numeral 10. Fuel assembly 10 is typical of that used in a pressurized water reactor (PWR), boiling water reactor (BWR), or other light water nuclear reactor, and includes a plurality of fuel rods 12, spacer grids 14, guide tubes 16, an upper end fitting or nozzle 18, and a lower end fitting or nozzle 20. In the installed configuration the fuel rods 12 are generally vertically oriented, although some deviation from exact gravitational vertical is contemplated. Fuel rods 12 are maintained in a spaced apart arrangement by spacer grids 14. Guide tubes 16 extend through the spacer grids 14 and are connected with the spacer grids 14, for example by welding, to form the structural skeleton of the fuel assembly 10. The guide tubes 16 connect at their upper ends with the upper end fitting 18, and connect at their lower ends with the lower end fitting 20. The guide tubes 16 are hollow tubes that serve as guides or conduits for control rods or in-core instrumentation (elements not shown). The lower end fitting 20 is the flow inlet to the fuel assembly 10, while the upper end fitting 18 is the flow outlet of the fuel assembly 10. The illustrative fuel assembly 10 is merely an example, and the fuel assembly may have different numbers of fuel rods, non-square cross-sections (e.g., a hexagonal cross-section in some embodiments), different numbers and arrangements of guide tubes, and so forth. The fuel assembly 10 further includes alignment pins 19 extending upward from the upper end fitting 18, and lower alignment pins 22 extending downward from the lower end fitting 20, that mate with features of a support plate, guide frames, or other components of the reactor (mating features/components not shown) to align the fuel assembly 10 with other components in the reactor. The alignment pins 19, 22 may be replaced by hollowed alignment pins, or other alignment features.

The fuel rods 12 include tapered bottom ends. This shape reduces the force required to insert the fuel rods 12 through the spacer grids 14, as well as reduces hydraulic drag at the flow channels entrance. The top ends of the fuel rods 12, shown in illustrative FIG. 1 as bullet-shaped heads with grapple features, may alternatively have other shapes.

With continuing reference to FIG. 1, the bottom ends of the fuel rods 12 are axially spaced from the lower end fitting 20 by a lower axial gap D_{L}. The top ends of the fuel rods 12 are axially spaced from the upper end fitting 18 by an upper axial gap D_{U}, which may be the same as or different from the lower axial gap D_{L}. The axial gaps D_{U}, D_{L} provide room for the cumulative axial growth of the fuel rod bundle relative to the axial growth evolution of the fuel assembly case, i.e. the guide tube bundle.

It is recognized herein, however, that these gaps D_{U}, D_{L} present unrealized thermal power generation potential. For example, consider fuel rods that emit H watts/unit length thermal power. If the reactor core includes N_{FA} fuel assemblies with N_{rods} rods per fuel assembly, then the unrealized thermal power generation potential is H×(D_{L}+D_{U})×N_{FA}×N_{rods}. In one contemplated small modular reactor (SMR) design (the mPower™ PWR reactor design of Babcock & Wilcox Company, see e.g. http://www.babcock.com/products/modular_nuclear/, last accessed Sep. 6, 2012) includes N_{FA}=69 fuel assemblies each comprising a 17×17 bundle of fuel rods (i.e., N_{rods}=289 rods). In such a reactor core, the unrealized thermal power generation potential due to the gaps D_{U}, D_{L} is about 20,000(D_{U}+D_{L})×H. In a percentage formulation, the unrealized thermal power generation potential is of order (D_{U}+D_{L})/D where D is the fuel rod length. (These are merely estimates, and the actual unrealized thermal power generation potential is influenced by fuel rod axial power shapes). One estimate for the foregoing reactor core design is that obtaining the unrealized thermal power generation potential would add up to about 1.0% to the core thermal power output.

Alternatively, the unrealized thermal power generation potential could be used to allow the reactor core to be run slightly cooler while generating the same thermal output (since the overall thermal output scales approximately with core volume, and the volume would also increase by order (D_{U}+D_{L})/D since the in-plane dimensions would be unchanged). In this case, the unrealized thermal power generation potential could be used to lengthen the fuel cycle. In the aforementioned example, a four year fuel cycle could potentially be increased by almost two weeks.

Recognizing that these gaps D_{U}, D_{L} present a substantial unrealized thermal power generation potential, it is disclosed herein to increase the fuel rod length by extending the bottom ends of the fuel rods into the lower end fitting, and/or by extending the top ends of the fuel rods into the lower end fitting. However, modification, while favorable from a thermal power output standpoint, introduces additional constraints and consideration requiring new innovations to enable realization of thermal power generation gains. As already noted, the gaps D_{U}, D_{L} accommodate thermal expansion of the fuel rods 12 during reactor operation. Additionally, the gaps D_{U}, D_{L} provide a degree of thermal isolation of the fuel rods 12 from the respective end fittings 18, 20. Further, extending the fuel rods into the upper and/or lower end fittings has the potential to interfere with the end fittings flow openings, which can inhibit their performance as nozzles, i.e. as the fluid inlet and outlet of the fuel assembly.

As disclosed herein, these issues are resolved by providing openings or through-holes in the end fittings to accommodate the extended fuel rod length. In some embodiments, these openings or through-holes are sized such that the fuel rods extend into the end fitting(s), but do not contact the end fitting(s). This provides some thermal isolation between the rod ends and the end fitting, and also facilitates fluid flow through the end fitting. Optionally, the alignment pins or other alignment features can be made partially or totally hollow to provide further fluid flow through the end fitting.

In an alternative approach, the end fittings can serve as end grids of the set of spacer grids. In these embodiments, the alternative end fittings hold the ends of the fuel rods, enabling the omission of conventional end grids. An additional benefit of the alternative approach is a decreased pressure drop across the end fittings in comparison to convention end fittings.

It is also recognized herein that by extending the ends of the fuel rods into the upper and/or lower end fittings, the increase in rod length is actually greater than the gap D_{U} and/or gap D_{L}. For example, extending the bottom ends of the fuel rods into the lower end fitting provides an increase in rod length of D_{L} plus the further extension of the bottom of the fuel rod into the lower end fitting.

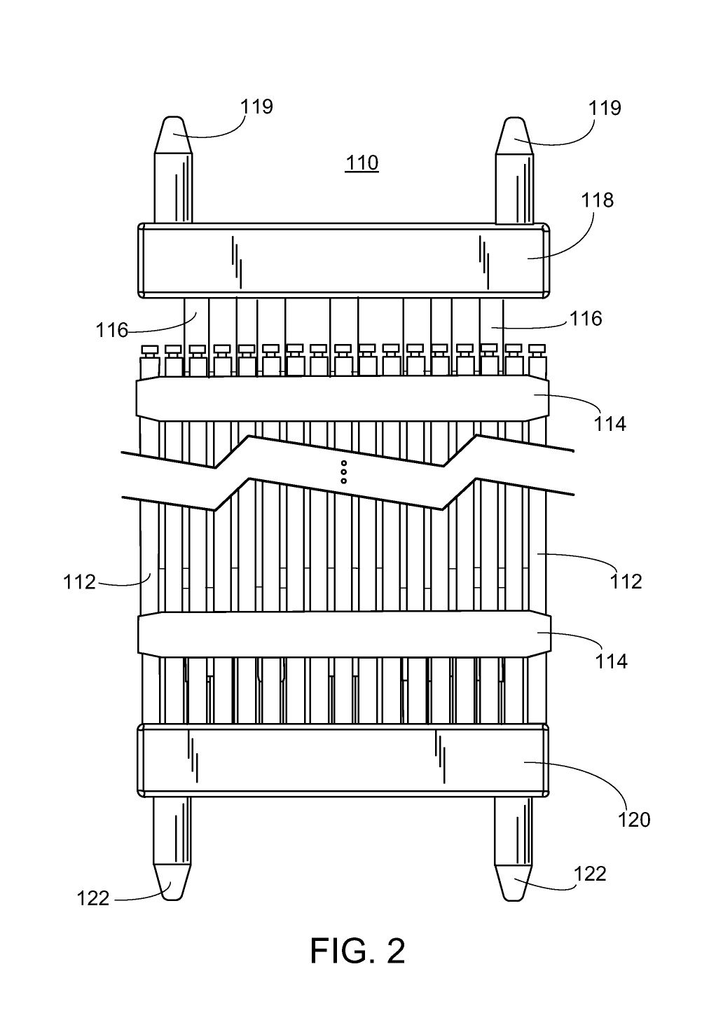

With reference to FIG. 2, a fuel assembly 110 includes a plurality of fuel rods 112, a set of spacer grids 114, guide tubes 116, an upper end fitting 118, a lower end fitting 120, upper alignment pins 119, and lower alignment pins 122. The fuel assembly of FIG. 2 differs from the fuel assembly of FIG. 1 in that the bottom ends of the fuel rods 112 extend into the lower end fitting 120, so that the gap D_{L} is eliminated. While the depicted embodiment illustrates the bottom ends of the fuel rods 112 extending into the lower end fitting 120, it should be understood that additionally or alternatively the top ends of the fuel rods 112 may extend into the upper end fitting 118.

By extending the fuel rods 112 into the upper end fitting 118 and/or the lower end fitting 120, the length of the fuel rods can be increased. In some embodiments, the extra length may be about 1″ for the upper cladding and about ¾″ for the lower cladding. The additional length(s) allows more fissile material (e.g. pellets) to be loaded into the fuel rods, such that the length of the fuel stack within the fuel rod is increased. In one arrangement, the lengthened fuel rod may include end caps, wherein at least a portion of the end caps do not contain a fissile material and the non fissile portion of end caps extends into the end grid. In another arrangement the end caps extend up to but not into the end grids. Advantageously, plenum volume may also be increased.

In general, the lengths of the fuel rods can be greater than the separation between the bottom surface of the upper end fitting 118 and the upper surface of the lower end fitting 120. This can be achieved by extending the bottom ends of the fuel rods 112 into the lower end fitting 120 by an amount greater than the gap D_{U} at the upper ends (as shown in FIG. 2), or by extending the top ends of the fuel rods into the upper end fitting by an amount greater than the gap D_{L} at the lower ends, or by extending both the top rod ends into the upper end fitting and the bottom rod ends into the lower end fitting.

In some embodiments, the ends of the fuel rods extend into openings or through-holes of the upper and/or lower end fitting. These openings or through-holes may be made larger than the diameter of the fuel rods, so that although the fuel rods extend into the end fitting they do not contact the end fitting. Such gaps provide thermal isolation of the ends of the fuel rods from the end fitting while maintaining a primary coolant flow channel, having a desired hydraulic pressure drop, through the end fitting.

Alternatively, the ends of the fuel rods extending into the end fitting can contact the end fitting (e.g. via grid springs), and the end fitting can serve as an end grid of the set of spacer grids. Conventionally (e.g., as in FIG. 1), the set of spacer grids 114 include a topmost end grid, a bottommost end grid, and several mid-grids located in-between the two end grids. In designing the fuel assembly to promote the nuclear chain reaction, which is driven by thermalized neutrons in a thermal nuclear reactor, the mid-grids are typically made of a zirconium alloy (e.g., Zircaloy) which has low neutron absorption; whereas, the end grids are typically made of a stronger material such as a nickel-chromium alloy (e.g., Inconel) which however is more neutron-absorbing. When a gap D_{L} exists between the bottom ends of the fuel rods 12 and lower end fitting 20 (as in FIG. 1), the lower end grid is located relatively close to the bottom ends of the fuel rods 12 to maintain proper spacing of the fuel rods 12 at their bottom ends.

On the other hand, when the bottom ends of the fuel rods 112 extend into the lower end fitting 120 (as in FIG. 2), the lower end fitting 120 optionally serves as an end grid of the set of spacer grids. The lowermost end grid may then be an Inconel end grid that is located further from the lower end fitting 120, or the Inconel end grid may be omitted entirely, with the lower end fitting 120 instead serving as the lower end grid. In these embodiments, the openings or through-holes of the end fitting are preferably manufactured to provide a firm yet non-rigid grip on the ends of the fuel rods. For example, the openings or through-holes of the end fitting can include structures similar to the springs and dimples of a conventional spacer grid. Such features may be machined into the end fitting (for example, if the end fitting is machined from a metal plate) or may be separately formed and welded inside the openings or through-holes. The use of such rod retention features also limits the contact area between the fuel rod and the end fitting, again serving to limit thermal conduction from the tops or bottoms of the hot fuel rod to the end fitting.

Extending the fuel rods into the end fitting can potentially increase the pressure drop over the end grid. This pressure drop can be reduced by employing through-holes that receive the ends of the fuel rods, with the through-holes having larger diameter than the fuel rods. In this way, an annular gap is present between the fuel rod and the through-hole, and these annular gaps can serve as flow holes.

In embodiments in which the end fitting serves as an end grid and contacts the ends of the fuel rods, the increased pressure drop across the end fitting may be compensated by elimination of the proximate end grid. The use of retention features analogous to the springs and dimples of a conventional spacer grid to hold the fuel rod ends can also provide gaps between the fuel rod and the opening or through-hole that can serve as flow paths.

The optional elimination of one or both of the end grids (by employing one or both end fittings as end grids) also reduces the force necessary to insert the fuel rods 112 through the spacer grids 114. The force reduction simplifies simultaneous and/or automated insertion of all of the fuel rods in automated (e.g. robotic) or semi-automated fashion leading to increased productivity, faster loading, and better accuracy (e.g. less deviation for controlling insertion parameters). The automated insertion process may also result in a more uniform as-built fuel assembly. The spacer grids 114 may be preheated (e.g. by local inductive heating) prior to insertion of the fuel rods 112.

As another approach for reducing the pressure drop over the end fitting, the upper alignment pins 119 and/or the lower alignment pins 122 may include a hollow passageway extending at least partially therethrough. The hollow passageway allows “smoother” hydraulic pressure drops localized around the alignment pin.

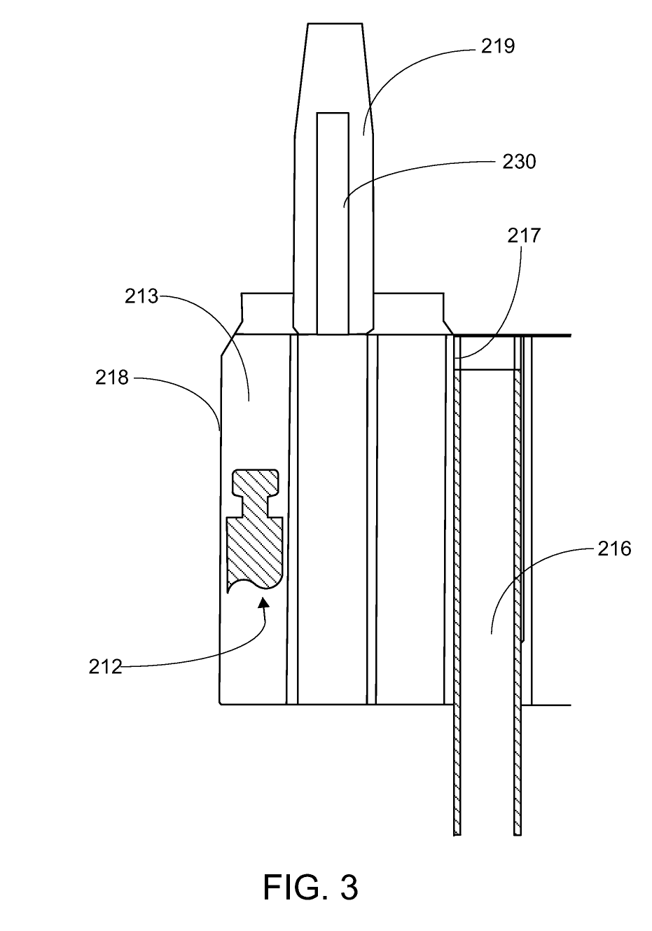

With reference to FIG. 3, a detail view is shown of a section of an upper end fitting 218 into which the fuel rods extend. (Unlike the embodiment shown in FIG. 2, in the embodiment of FIG. 3 the top ends of the fuel rods extend into the upper end fitting 218. The bottom ends and bottom end fitting are not shown in FIG. 3, and the bottom ends of the fuel rods may or may not extend into the bottom end fitting.) A fuel rod 212 and a guide tube 216 are shown extending into the upper end fitting 218. The upper end of the guide tube 216 is connected with the upper end fitting 218 by a connector 217 capable of enabling thru passage of a control rod. (If the guide tube 216 needs to have an open upper end, e.g. to admit a control rod, then an alternative fastening arrangement can be employed.) The top end of the fuel rod 212 extends into an opening or through-hole 213 of the upper end fitting 218. To accommodate thermal expansion of the fuel rod 212 during reactor operation, the opening or through-hole 213 should be deep enough to accommodate this thermal expansion. (In the case of a through-hole, the upper end fitting 218 should be thick enough such that the fuel rod under thermal expansion does not extend above the upper surface of the upper end fitting 218, yet restrictive enough at a top portion such that axial slippage through the top of the upper end fitting 218 during postulated licensing events is inhibited.) The illustrative upper end fitting 218 further includes an alignment pin 219 extending upward from the top of the upper end fitting 218. The upper end alignment pin includes a hollow passageway 230 that provides additional flow path to reduce the pressure drop over the upper end fitting 218. The hollow passageway 230 is not shown extending completely to the upper end of the alignment pin 219, but could have side-holes (not shown) to allow lateral flow out of the pin 219, or alternatively the hollow passageway can be made to extend completely through the alignment pin.

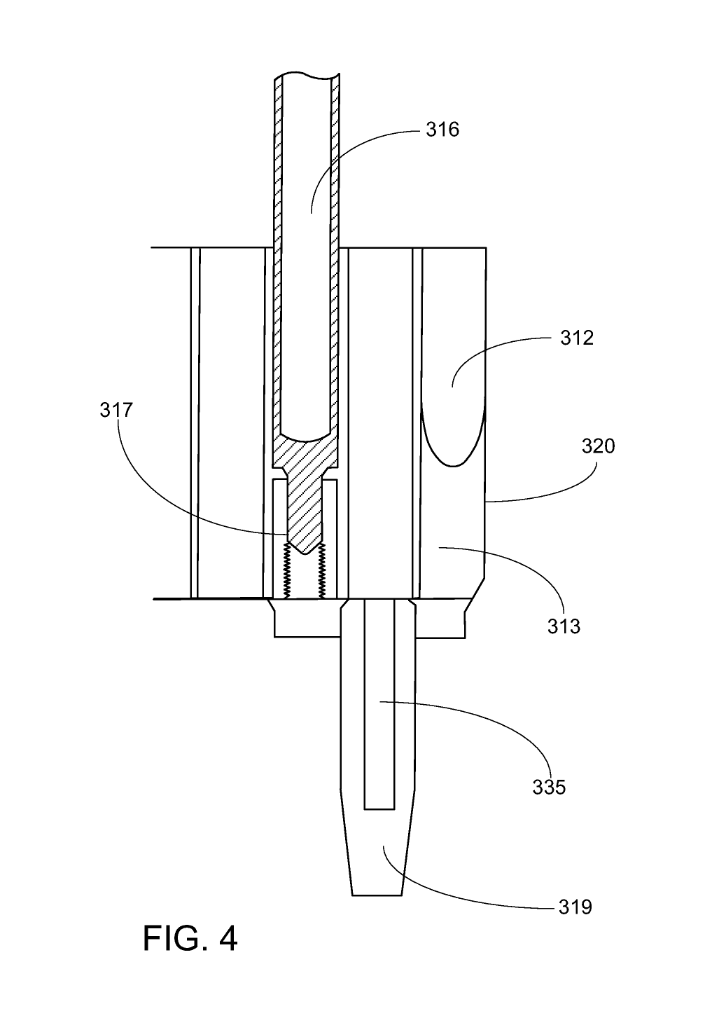

With reference to FIG. 4, detail view is shown of a section of a lower end fitting 320 of the present disclosure. (In some embodiments, the lower end fitting 320 is identical with the lower end fitting 120 of FIG. 2). A fuel rod 312 and a guide tube 316 are shown extending into the lower end fitting 320. The lower end of the guide tube 316 is connected with the lower end fitting 320 by a threaded male portion 317. (Again, an alternative fastening arrangement can be employed.) The bottom end of the fuel rod 312 is bullet-shaped and extends into an opening or through-hole 313 of the lower end fitting 320. To accommodate thermal expansion of the fuel rod 312 during reactor operation, the opening or through-hole 313 should be deep enough (or, in the case of a through-hole, the lower end fitting 320 should be thick enough) to accommodate this thermal expansion. The lower end fitting 320 further includes an alignment pin 319 extending downward from the bottom of the lower end fitting 320. The lower end alignment pin 319 includes a hollow passageway 335 which serves to reduce the pressure drop over the lower end fitting 320.

Embodiments in which the ends of the fuel rods extend into through-holes have the advantage that (assuming the through-hole is of larger diameter than the fuel rod) the annular gap between the fuel rod and the through-hole can serve as a fluid flow path. Additionally, thermal expansion of the fuel rod is accommodated by a through-hole so long as the end fitting is of sufficient thickness. On the other hand, a through-hole does nothing to prevent rod ejection, which is a credible accident scenario in some reactor designs. Conversely, embodiments in which the ends of the fuel rods extend into openings which are plugged provide protection against rod ejection, but do not provide a fluidic flow path. In a contemplated “hybrid” approach, the ends of the fuel rods extend into through-holes which are however constricted at the end opposite to the end at which the fuel rod enters (that is, constricted at the upper end of a through-hole through an upper end fitting, or constricted at the lower end of a through-hole through a lower end fitting). By making the constriction of smaller diameter than the fuel rod diameter, the constriction prevents rod ejection while still permitting some fluid flow.

The preferred embodiments have been illustrated and described. Obviously, modifications and alterations will occur to others upon reading and understanding the preceding detailed description. It is intended that the invention be construed as including all such modifications and alterations insofar as they come within the scope of the appended claims or the equivalents thereof.

We claim:

1. An apparatus comprising:
a fuel assembly including:
a plurality of fuel rods comprising fissile material and arranged mutually in parallel,
a plurality of guide tubes arranged in parallel with and interspersed amongst the fuel rods,
an upper end fitting connected with upper ends of the guide tubes, and
a lower end fitting connected with lower ends of the guide tubes,
wherein at least one of (1) the top ends of the fuel rods extend into the upper end fitting and (2) the bottom ends of the fuel rods extend into the lower end fitting.

2. The apparatus of claim 1, wherein the top ends of the fuel rods extend into the upper end fitting.

3. The apparatus of claim 2, wherein the top ends of the fuel rods extend into recesses in the upper end fitting.

4. The apparatus of claim 2, wherein the top ends of the fuel rods extend into through-holes passing through the upper end fitting.

5. The apparatus of claim 2, wherein the top ends of the fuel rods extend into recesses or through-holes of the upper end fitting but do not contact the upper end fitting.

6. The apparatus of claim 5, wherein the fuel assembly further comprises:
a set of spacer grids connected with the guide tubes and holding the plurality of fuel rods in a spaced-apart arrangement.

7. The apparatus of claim 2, wherein the fuel assembly further includes:
a set of spacer grids connected with the guide tubes and holding the plurality of fuel rods in a spaced apart arrangement;
wherein the top ends of the fuel rods are held by the upper end fitting such that the upper end fitting serves as an end grid of the set of spacer grids.

8. The apparatus of claim 2, wherein the upper end fitting includes alignment pins extending upward from the upper end fitting, each alignment pin having a hollow passageway extending at least partially through the alignment pin.

9. The apparatus of claim 1, wherein the bottom ends of the fuel rods extend into the lower end fitting.

10. The apparatus of claim 9, wherein the bottom ends of the fuel rods extend into recesses in the lower end fitting.

11. The apparatus of claim 9, wherein the bottom ends of the fuel rods extend into through-holes passing through the lower end fitting.

12. The apparatus of claim 9, wherein the bottom ends of the fuel rods extend into recesses or through-holes of the lower end fitting but do not contact the lower end fitting.

13. The apparatus of claim 12, wherein the fuel assembly further comprises:
a set of spacer grids connected with the guide tubes and holding the plurality of fuel rods in a spaced-apart arrangement.

14. The apparatus of claim 9, wherein the fuel assembly further includes:
a set of spacer grids connected with the guide tubes and holding the plurality of fuel rods in a spaced apart arrangement;
wherein the bottom ends of the fuel rods are held by the lower end fitting such that the lower end fitting serves as an end grid of the set of spacer grids.

15. The apparatus of claim 9, wherein the lower end fitting includes alignment pins extending downward from the lower end fitting, each alignment pin having a hollow passageway extending at least partially through the alignment pin.

16. The apparatus of claim 9, wherein the bottom ends of the fuel rods are bullet-shaped.

17. A pressurized water reactor (PWR) including a plurality of fuel assemblies as set forth in claim 1 assembled as a nuclear reactor core of the PWR.

18. An apparatus comprising:
a fuel assembly including:
a bundle of fuel rods comprising fissile material,
a plurality of guide tubes interspersed amongst the fuel rods of the bundle of fuel rods,
a set of spacer grids connected with the guide tubes and holding the fuel rods of the bundle of fuel rods in a spaced-apart arrangement,
an upper end fitting connected with upper ends of the guide tubes, and
a lower end fitting connected with lower ends of the guide tubes,
wherein the fuel rods are longer than the distance between the lower surface of the upper end fitting and the upper surface of the lower end fitting.

19. The apparatus of claim 18, wherein the fuel rods extend into openings or through-holes of the upper end fitting.

20. The apparatus of claim 18, wherein the fuel rods extend into openings or through-holes of the lower end fitting.

21. The apparatus of claim 18, wherein the fuel rods extend into openings or through-holes of the upper end fitting and extend into openings or through-holes of the lower end fitting.
